(19) United States
(12) Patent Application Publication
(10) Pub. No.: US 2023/0175153 A1
(43) Pub. Date: Jun. 8, 2023

(54) METHOD OF MANUFACTURING ELECTRODE FOR WATER ELECTROLYSIS AND ELECTRODE FOR WATER ELECTROLYSIS MANUFACTURED THEREBY

(71) Applicants: HYUNDAI MOTOR COMPANY, Seoul (KR); KIA CORPORATION, Seoul (KR); KOREA ADVANCED INSTITUTE OF SCIENCE AND TECHNOLOGY, Daejeon (KR)

(72) Inventors: Seung Hyeon Choi, Seoul (KR); Hoon Mo Park, Seongnam-si (KR); Min Ju Park, Seoul (KR); Se Young Lee, Suwon-si (KR); Eun Ae Cho, Daejeon (KR); Dong Hoon Song, Pohang-si (KR); Hyo Won Kim, Daegu (KR); Yong Keun Kwon, Bucheon-si (KR); Jeong Han Roh, Daejeon (KR)

(21) Appl. No.: 17/967,394

(22) Filed: Oct. 17, 2022

(30) Foreign Application Priority Data
Dec. 2, 2021 (KR) 10-2021-0171034

(51) Int. Cl. C25B 11/091; C25B 11/052; C25B 1/04

(52) U.S. Cl. CPC C25B 11/091; C25B 1/04; C25B 11/052

(57) ABSTRACT

A method of manufacturing an electrode for water electrolysis having high catalytic activity for a hydrogen evolution reaction by forming a catalyst layer in which molybdenum oxide and a Ni-Mo-based alloy are mixed and an electrode for water electrolysis manufactured thereby are described. The method includes preparing catalyst materials including a solvent, a nickel (Ni) precursor, a molybdenum (Mo) precursor, and sodium citrate, preparing an electrode base material, obtaining a plating solution by dissolving the nickel (Ni) precursor, the molybdenum (Mo) precursor, and the sodium citrate in the solvent, and forming a catalyst layer on the surface of the electrode base material by immersing the electrode base material in the plating solution and applying an electric current.

### CROSS REFERENCE TO RELATED APPLICATIONS

The present application claims priority to Korean Patent Application No. 10-2021-0171034, filed Dec. 2, 2021, the entire contents of which is incorporated herein for all purposes by this reference.

### BACKGROUND

### 1. Field of the Disclosure

The present disclosure relates to a method of manufacturing an electrode for water electrolysis and an electrode for water electrolysis manufactured thereby. More particularly, the present disclosure relates to a method of manufacturing an electrode for water electrolysis having high catalytic activity for a hydrogen evolution reaction by forming a catalyst layer in which molybdenum oxide and a Ni-Mo-based alloy are mixed, and an electrode for water electrolysis manufactured thereby.

### 2. Description of the Related Art

Electrochemical water decomposition, that is, water electrolysis, occurs in two reactions: a hydrogen evolution reaction (HER) performed by a reduction reaction at the cathode and an oxygen evolution reaction (OER) performed by an oxidation reaction at the anode. That is, water electrolysis is an energy storage technology that can store energy in the form of hydrogen by using electric energy.

Ideally, such a water electrolysis reaction may proceed when a voltage of 1.23 V is applied. However, in order to perform the actual water electrolysis reaction, a voltage of 1.23 V or more is required due to the high overvoltage of the oxygen evolution reaction and the hydrogen evolution reaction and is a major cause of low water electrolysis efficiency. Therefore, it is necessary to develop an electrode catalyst to lower a high overvoltage.

A platinum catalyst is known to be the most active hydrogen evolution reaction electrode in water electrolysis. Water electrolysis is divided according to the electrolyte used, and representatively, there is water electrolysis driven in an acidic environment and water electrolysis driven in a basic environment.

In the water electrolysis driven in an acidic environment, the platinum electrode is so active that there is no non-precious metal catalyst to replace, and in the basic environment, a nickel substrate, etc., with a low price is used due to the high price of the platinum catalyst.

However, nickel substrates exhibit low hydrogen evolution reaction activity, which is one of the causes of the low efficiency of water electrolysis devices. Therefore, the development of electrodes with a platinum level of hydrogen evolution reaction activity in acidic environments and the increase in activities in basic environments are problems to be solved in order to increase water electrolysis efficiency.

In order to solve this problem, attempts have been steadily made to develop a catalyst having high hydrogen evolution reaction activity by creating a compound form in which a heterogeneous material is added to nickel. Therefore, it has been reported that the nickel-molybdenum alloy catalyst has an excellent hydrogen evolution reaction among various materials.

However, since most of the studies so far have been limited to the control of the alloy ratio of nickel-molybdenum or the shape control of the nickel-molybdenum alloy catalyst, both acid/basic properties have shown still low performance. That is, the nickel-molybdenum heterogeneous compound still has a problem that the activity of the hydrogen evolution reaction is low.

In other words, the hydrogen evolution reaction is generated according to the reaction described in Table 1 below.

TABLE 1

| | | |
|---|---|---|
| Division | Acid | Basic |
| Volmer reaction | 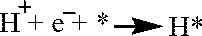 | 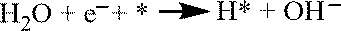 |
| Tafel reaction | 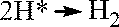 | 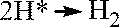 |
| Heyrovsky reaction | 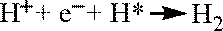 | 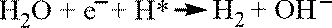 |

As shown in Table 1, as hydrogen ions or water in the electrolyte are reduced, a Volmer reaction in which hydrogen is adsorbed to the catalyst surface occurs. Thereafter, the Tafel reaction in which hydrogen gas is generated by the reaction between the adsorbed hydrogen or the Heyrovsky reaction in which the adsorbed hydrogen and another hydrogen supplied from the electrolyte meet to generate hydrogen gas occurs and hydrogen is generated. Nickel, a representative non-precious metal hydrogen evolution reaction catalyst material, is known to have strong hydrogen adsorption characteristics and thus is relatively advantageous for Volmer reactions. However, strong hydrogen adsorption strength adversely affects the Tafel and Heyrovsky reactions, resulting in a slow overall hydrogen generation reaction.

A nickel-molybdenum alloy formed by introducing the heterogeneous molybdenum material to the nickel electrode may increase water decomposition activity to speed up basic Volmer and Heyrovsky reactions, including water decomposition reactions.

Therefore, the nickel-molybdenum alloy electrode has been invented as an electrode for the hydrogen evolution reaction of water electrolysis driven in a basic environment.

However, due to the strong hydrogen adsorption characteristics, the reaction of releasing hydrogen as a gas occurs slowly, which has limitations in catalytic activity.

The description as the background technology is intended to understand the background of the present disclosure and to recognize that it corresponds to the related art that is already known to those skilled in the art.

### SUMMARY

The present disclosure provides a method of manufacturing an electrode for water electrolysis having high catalytic activity for a hydrogen evolution reaction by forming a catalyst layer in which molybdenum oxide and a nickel-molybdenum (Ni—Mo) alloy are mixed, and an electrode for water electrolysis prepared thereby.

The method of manufacturing an electrode for water electrolysis, according to an embodiment of the present disclosure, is a method of manufacturing an electrode used for water electrolysis includes a catalyst material preparation step for preparing a solvent, a nickel (Ni) precursor, a molybdenum (Mo) precursor, and sodium citrate, respectively, an electrode base material preparation step for preparing an electrode base material, a plating solution generating step of generating a plating solution by dissolving a nickel (Ni) precursor, a molybdenum (Mo) precursor, and sodium citrate in a solvent; and an electrode plating step of forming a catalyst layer on the surface of the electrode base material by immersing the electrode base material in the prepared plating solution and applying a current thereto.

In the catalyst material preparation step, the solvent is prepared with distilled water, and the nickel precursor may be prepared as a compound including at least one nickel chloride, nickel sulfide, nickel sulfate, and nickel acetate, and hydrates thereof. The molybdenum precursor is prepared as a compound including at least one of sodium molybdate, ammonium molybdate, and hydrates thereof.

In the electrode base material preparation step, the electrode base material may be prepared by preparing copper (Cu) or nickel (Ni) in a foam shape or a plate shape.

The electrode base material preparation step includes an electrode base material forming process for preparing the electrode base material by molding, and an oxide film removal process of removing the oxide film formed on the surface of the molded electrode base material.

The plating solution generating step is characterized in that the nickel precursor, sodium citrate, and molybdenum precursor are sequentially dissolved in a prepared solvent.

The plating solution generating step may dissolve 0.05 M to 0.3 M of a nickel precursor, 0.1 M to 0.6 M of sodium citrate, and 1 mM to 10 mM of a molybdenum precursor in a prepared solvent.

The plating solution generating step may dissolve 0.1 M to 0.2 M of a nickel precursor, 0.1 M to 0.4 M of sodium citrate, and 1.25 mM to 10 mM of a molybdenum precursor in a prepared solvent.

The electrode plating step includes an electroplating process of applying a current to the electrode base material immersed in the plating solution at an applied current density of 0.1 A/cm² to 3 A/cm².

The electroplating process is performed at 30 to 600 seconds.

The electrode plating step further includes a plating preparation step of stirring the plating solution prepared before performing the electroplating process at 300 rpm or more and maintaining the temperature of the plating solution at 20° C. to 40° C.

On the other hand, an electrode for water electrolysis, according to an embodiment of the present disclosure, is an electrode used for water electrolysis including an electrode base material, a catalyst layer formed on a surface of the electrode base material and obtained by mixing Mo oxide and a Ni—Mo—based alloy.

The catalyst layer is deposited such that Mo oxide and a nano-sized Ni—Mo—based alloy are uniformly distributed on the surface of the electrode base material.

The catalyst layer may be formed in an amount of Ni— 30 to 55 wt%, Mo— 19 to 30 wt%, and O: 20 to 45 wt%.

According to an embodiment of the present disclosure, a catalyst layer in which molybdenum oxide and a Ni—Mo—based alloy are mixed is formed on the surface of an electrode base material, thereby implementing an electrode having high activity in a hydrogen generation reaction.

In particular, the structure in which the Ni—Mo—based alloy is uniformly distributed in molybdenum oxide can overcome the active limit of the conventional nickel-molybdenum electrode.

In addition, according to an embodiment of the present disclosure, hydrogen evolution reaction activity similar to that of expensive noble metal-based catalysts can be exhibited under acidic conditions, and hydrogen evolution reaction activity superior to expensive noble metal-based catalysts can be exhibited under basic conditions, and the effect of realizing an electrode with excellent durability can be expected.

### BRIEF DESCRIPTION OF THE FIGURES

FIG. 1A is an SEM image of an electrode specimen according to a Comparative Example;

FIGS. 1B and 1C are SEM images of electrode specimens according to the Example;

FIGS. 2A and 2B are images showing the STEM image and EDS mapping results according to the Example;

FIGS. 3A, 3B, 3C, 3D, 3E, and 3F are graphs comparing the hydrogen evolution reaction activity of electrode specimens according to Comparative Examples and Examples;

FIG. 3G is a STEM image and EDS mapping result of Comparative Example 5;

FIG. 4A is a high-resolution TEM image of the electrode specimen according to Example 1;

FIG. 4B is an XRD analysis result of the electrode specimen according to Example 1; and

FIGS. 5A and 5B are results of XPS binding energy for each catalytic element of the electrode specimen according to Example 1.

### DETAILED DESCRIPTION

Hereinafter, embodiments of the present disclosure will be described in more detail with reference to the accompanying drawings. However, the present disclosure is not limited to the embodiments disclosed below but will be implemented in various different forms, and only the present embodiments are provided to ensure that the disclosure of the present disclosure is complete and to fully inform those skilled in the art.

The method of manufacturing an electrode for water electrolysis, according to an embodiment of the present disclosure, is a method of manufacturing an electrode used for water electrolysis includes a catalyst material preparation step for preparing a solvent, a nickel (Ni) precursor, a molybdenum (Mo) precursor, and sodium citrate, respectively, an electrode base material preparation step for preparing an electrode base material, a plating solution generating step of generating a plating solution by dissolving a nickel (Ni) precursor, a molybdenum (Mo) precursor, and sodium citrate in a solvent, and an electrode plating step of forming a catalyst layer on the surface of the electrode base material by immersing the electrode base material in the prepared plating solution and applying a current thereto.

Thus, the electrode for water electrolysis is manufactured by the method for manufacturing an electrode for water electrolysis includes an electrode base material, a catalyst layer formed on a surface of the electrode base material and mixed with molybdenum oxide and a Ni—Mo—based alloy.

At this time, the catalyst layer is formed by depositing molybdenum oxide and a nano-sized Ni—Mo—based alloy on the surface of the electrode base material to be uniformly distributed.

Hereinafter, a method of manufacturing an electrode for water electrolysis according to an embodiment of the present disclosure will be described in detail step by step.

First, the catalyst material preparation step is preparing a solvent, a nickel (Ni) precursor, a molybdenum (Mo) precursor, and sodium citrate required for preparing a plating solution, respectively.

Here, distilled water is prepared as a solvent.

In addition, the nickel precursor and the molybdenum precursor are prepared as a compound that can dissolve well in distilled water.

For example, the nickel (Ni) precursor is prepared as a compound including at least one of nickel chloride, nickel sulfide, nickel sulfate, nickel acetate, and hydrates thereof.

In addition, the molybdenum precursor is prepared as a compound including at least one of sodium molybdate, ammonium molybdate, and hydrates thereof.

Then, sodium citrate is prepared.

Next, the electrode base material preparation step is preparing an electrode base material for forming a catalyst layer by an electroplating method using a plating solution.

The preparation stage of the electrode base material includes an electrode base material molding process prepared by molding the electrode base material and an oxide film removal process that removes the oxide film formed on the surface of the molded electrode base material.

Therefore, the electrode base material is firstly molded and prepared through the electrode base material molding process. In this case, the electrode base material may include copper (Cu) or nickel (Ni) in a foam shape or a plate shape.

Then, an oxide film is formed on the surface of the prepared electrode base material and is to form a catalyst layer smoothly. An oxide film removal process of removing the oxide film formed on the surface of the electrode base material is performed.

The oxide film removing process may remove the oxide film formed on the surface of the electrode base material by immersing the molded electrode base material in 20 wt% HCL for 3 minutes.

Next, the plating solution generating step is generating a plating solution used in the electroplating method, and a nickel precursor, sodium citrate, and molybdenum precursor are dissolved in a prepared solvent. At this time, it is preferable not to simultaneously dissolve the nickel precursor, the sodium citrate, and the molybdenum precursor in the solvent but to sequentially dissolve the nickel precursor, the sodium citrate, and the molybdenum oxide in the solvent in order to suppress cluster formation of nickel and molybdenum ions and for smooth molybdenum and molybdenum oxide deposition.

If the nickel precursor, the sodium citrate, and the molybdenum precursor are not sequentially dissolved in the solvent and dissolved in other orders or simultaneously, due to the formation of clusters of nickel and molybdenum ions, there may be a problem in that a catalyst layer including the desired level of Mo oxide and a Ni—Mo—based alloy is not formed on a surface of an electrode base material.

On the other hand, in the plating solution generation step, the dissolution ratio of the nickel precursor, sodium citrate, and molybdenum precursor is 0.05 M to 0.3 M of the nickel precursor, 0.1 M to 0.6 M of sodium citrate, and 1 mM to 10 mM of molybdenum precursor. More desirably, it would be better to dissolve 0.1 M to 0.2 M of the nickel precursor, 0.1 M to 0.4 M of the sodium citrate, and 1.25 mM to 10 mM of the molybdenum precursor in the solvent.

Finally, the electrode plating step is forming a catalyst layer on the surface of the electrode base material by electroplating by immersing the electrode base material in the prepared plating solution and applying an electric current.

In the electrode plating step, before performing the electroplating method, the prepared plating solution is stirred at 300 rpm or more to facilitate diffusion of the molybdate-citrate cluster, and a plating preparation process is performed to maintain the temperature of the plating solution at 20° C. to 40° C., preferably 30° C.

Then, after stirring, an electroplating process is performed to immerse the prepared electrode base material in the plating solution in which the temperature is maintained and apply a current to the plating solution.

At this time, a current is applied to the electrode base material immersed in the plating solution with an applied current density of 0.1 A/cm² to 3 A/cm² and maintained for 30 to 600 seconds so that the catalyst layer is sufficiently formed on the electrode base material.

When the electroplating process is completed, a catalyst layer in which molybdenum oxide and a nano-sized Ni—Mo—based alloy are uniformly mixed and distributed on the surface of an electrode base material may be formed. In this case, the catalyst layer is preferably formed of Ni: 30 wt% to 55 wt%, Mo: 19 wt% to 30 wt%, and O: 20 wt% to 45 wt%.

Such a catalyst layer may be used as a catalyst having high activity in the hydrogen evolution reaction.

Next, the present disclosure will be described using comparative examples and examples.

Electrode specimens were prepared under the conditions shown in Table 2 below, and the effects of the electrode specimens according to Examples are described through various tests on the prepared specimens. At this time, the conditions not shown in Table 2 below were prepared by an electrode specimen according to a preferred embodiment of the present disclosure.

TABLE 2

| | | | | | | |
|---|---|---|---|---|---|---|
| Division | Electrode base material | Ni precursor Concentration (M) | Mo precursor Concentration (mM) | Sodium citrate concentration (M) | Pt/C | Applied current density (A/cm2) |
| Comparative Example 1 | With | - | - | - | - | - |
| Comparative Example 2 | Ni | - | - | - | - | - |
| Example 1 | Ni | 0.1 | 2.5 | 0.2 | - | 0.5 |
| Example 2 | Ni | 0.1 | 1.25 | 0.2 | - | 0.5 |
| Example 3 | Ni | 0.1 | 5 | 0.2 | - | 0.5 |
| Example 4 | Ni | 0.1 | 10 | 0.2 | - | 0.5 |
| Example 5 | Ni | 0.1 | 20 | 0.2 | - | 0.5 |
| Example 6 | Ni | 0.1 | 2.5 | 0.2 | - | 0.1 |
| Example 7 | Ni | 0.1 | 2.5 | 0.2 | - | 1 |
| Example 8 | Ni | 0.1 | 2.5 | 0.2 | - | 3 |
| Example 9 | Ni | 0.05 | 1.25 | 0.1 | - | 0.5 |
| Example 10 | Ni | 0.2 | 5 | 0.4 | - | 0.5 |
| Example 11 | Ni | 0.3 | 7.5 | 0.6 | - | 0.5 |
| Example 12 | Ni | 0.1 | 2.5 | 0.05 | - | 0.5 |
| Example 13 | Ni | 0.1 | 2.5 | 0.4 | - | 0.5 |
| Example 14 | Ni | 0.1 | 2.5 | 0.2 | - | 0.5 |
| Comparative Example 3 | Ni | 0.1 | - | 0.2 | - | 0.5 |
| Comparative Example 4 | Ni | - | - | - | Pt ratio 20 wt% | - |
| Comparative Example 5 | Ni—Mo alloy | - | - | - | - | - |

### 1. Comparison of Surface Images of Electrode Specimens

First, the SEM images of the prepared electrode specimens are compared.

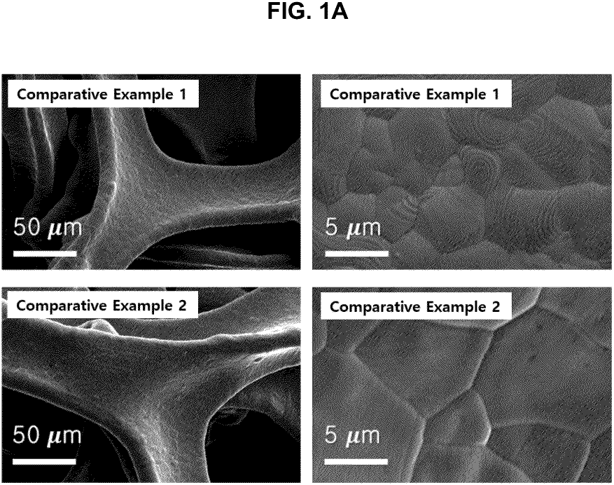

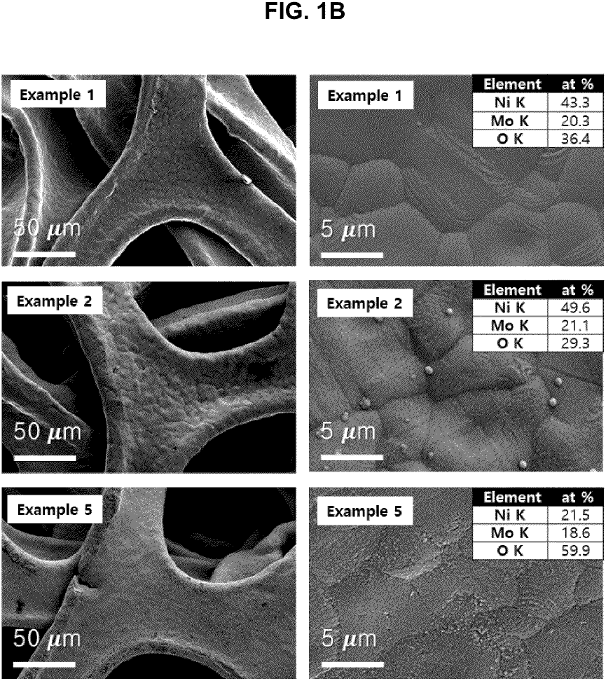

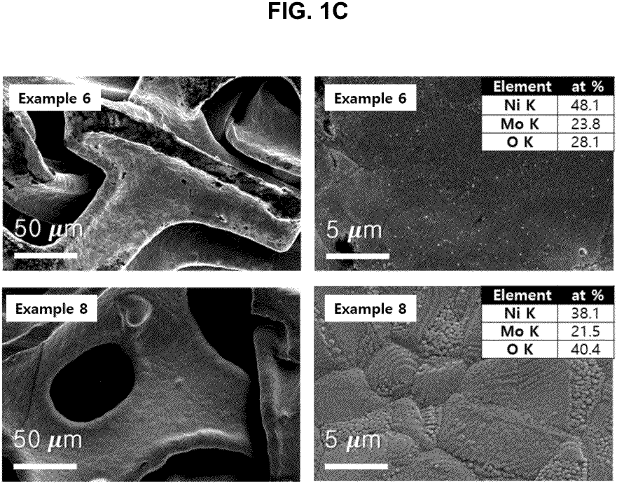

FIG. 1A is a SEM image of an electrode specimen according to a Comparative Example and FIGS. 1B and 1C are SEM images of an electrode specimen according to an Example.

Comparing FIGS. 1A, 1B, and 1C, in the electrode specimen prepared according to the embodiment, it was confirmed that molybdenum oxide and a Ni—Mo—based alloy forming a catalyst layer were deposited on a surface thereof along with the shape of the electrode base material.

### 2. Comparison of Deposition Distribution of Molybdenum Oxide and Ni-Mo-Based Alloy According to the Concentration of Molybdenum in a Plating Solution

Comparing FIGS. 1A, 1B, and 1C, when comparing Examples 1, 2, and 5, it can be seen that the oxygen content in the electrode specimen increases as the concentration of the molybdenum precursor increases.

Comparing Examples 1, 6, and 8, it can be seen that the oxygen content in the electrode specimen increases as the applied current density increases in the plating solution of the same molybdenum precursor concentration.

In addition, comparing Examples 1, 2, 5, 6, and 8, it can be seen that the deposition amount of molybdenum oxide increases as the oxygen content in the electrode specimen increases.

Therefore, it can be seen that the deposition amount of molybdenum oxide increases as the molybdenum concentration of the plating solution increases.

### 3. Comparison of Nickel and Molybdenum Distribution and Hydrogen Evolution Reaction Activity in Electrode Specimens According to Comparative Examples and Examples

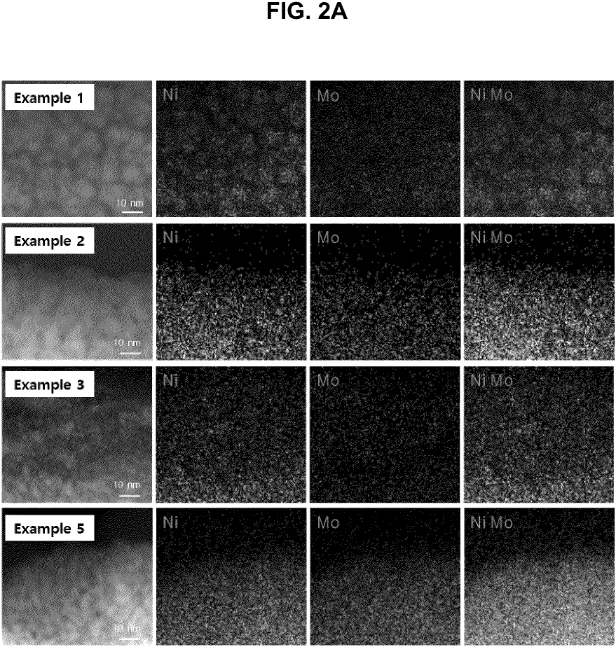

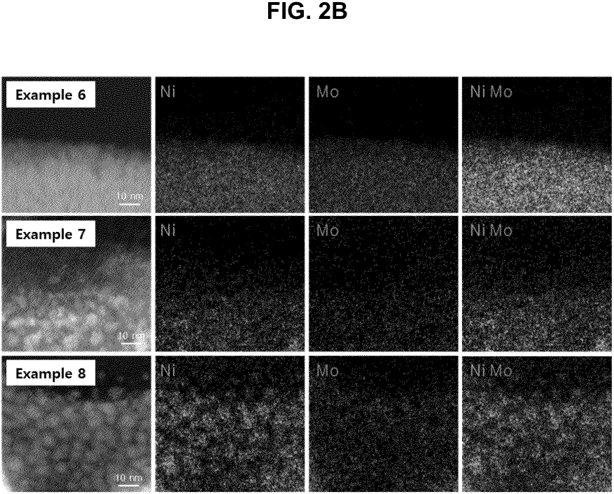

FIGS. 2A and 2B are images showing STEM images and EDS mapping results according to Examples.

Firstly, comparing Examples 1, 2, 3, and 5 of FIG. 2A, it can be seen that in Example 2, having the lowest concentration of the molybdenum precursor, there was no clear distinction between molybdenum oxide and the Ni-Mo-based alloy. In Example 1 in which the concentration of the molybdenum precursor was optimally adjusted, the aspect in which molybdenum oxide is mixed between the Ni-Mo-based alloys can be observed relatively clearly, and in Example 5, in which the concentration of the molybdenum precursor is the highest, it can be seen that there is no clear distinction between molybdenum oxide and Ni-Mo-based alloys.

Comparing Example 1 of FIG. 2A with Examples 6, 7, and 8 of FIG. 2B, it can be seen that the applied current density has an effect on the microstructure. It can be seen that in Example 6 in which the applied current density is the lowest at 0.1 A/cm² there is no clear distinction between molybdenum oxide and the Ni-Mo-based alloy. In the Example prepared with a higher applied current density, that is, Examples 1, 7, and 8 in which the applied current densities were 0.5 A/cm², 1 A/cm², and 3 A/cm², respectively, it can be seen that molybdenum oxide and the Ni-Mo-based alloy are distinguished.

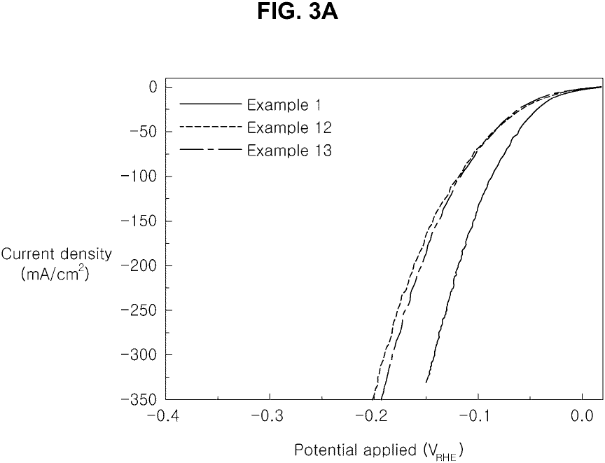

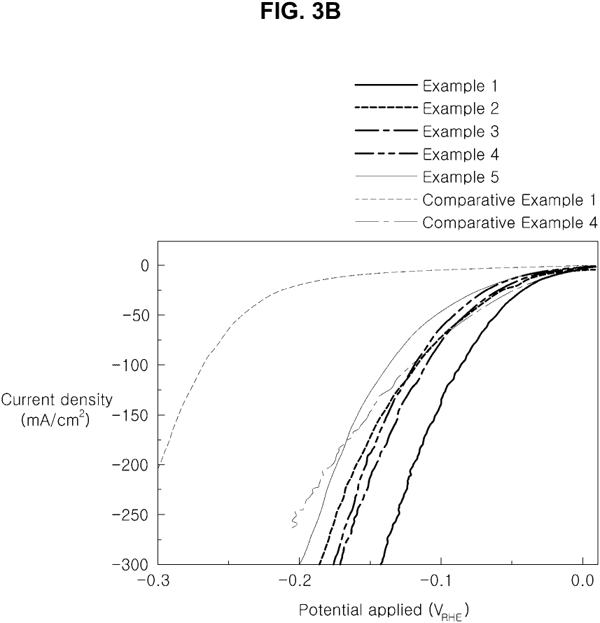

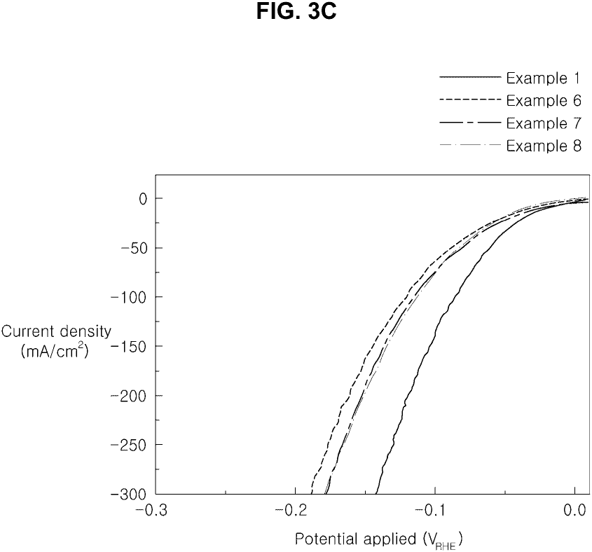

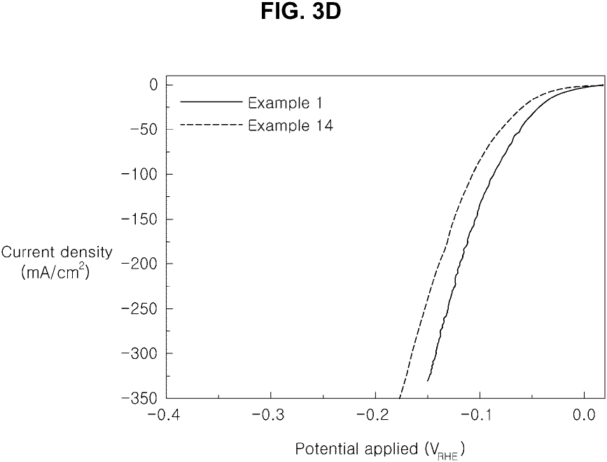

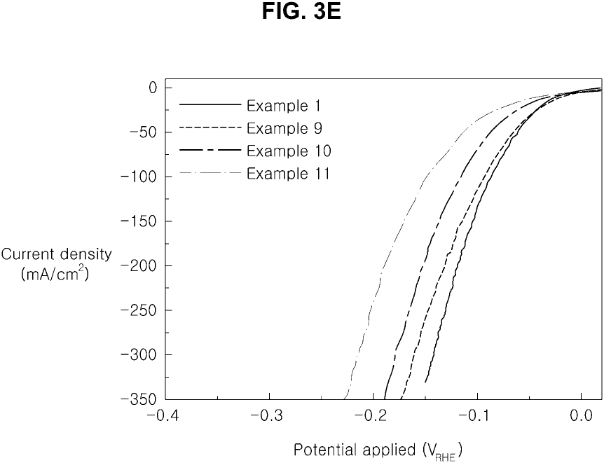

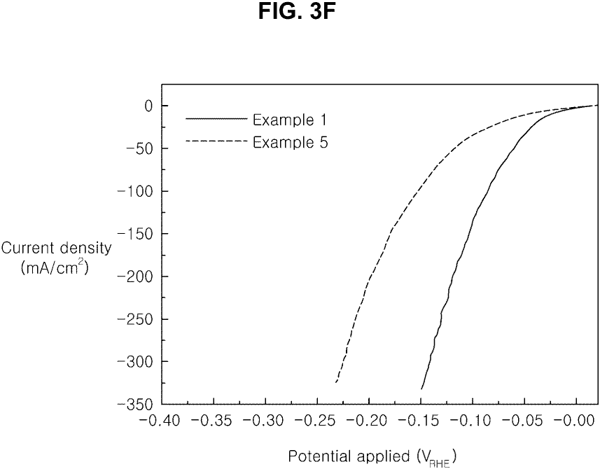

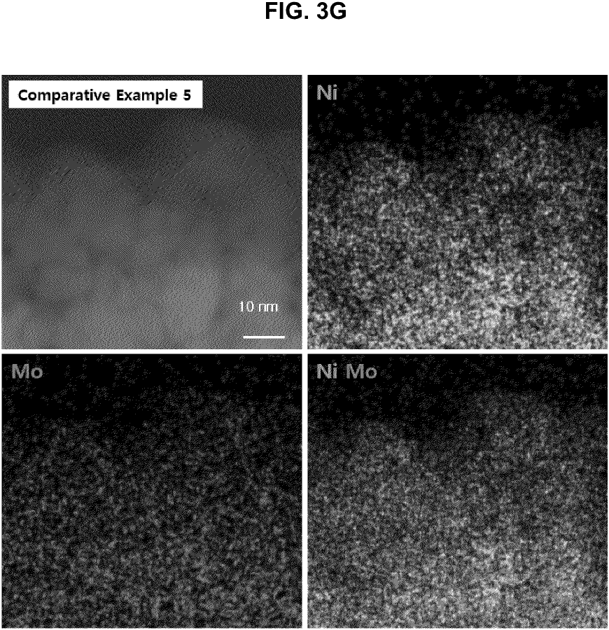

In addition, FIGS. 3A to 3F are graphs comparing the hydrogen evolution reaction activity of electrode specimens according to Comparative Examples and Examples and FIG. 3G is a STEM image and EDS mapping result of Comparative Example 5.

FIG. 3A is a graph showing the hydrogen evolution reaction activity of the specimens prepared in Examples 12 and 13 by adjusting the sodium citrate concentration to ¼ and 2 times based on Example 1 to limit the concentration range of sodium citrate. In the absence of citrate ions, cluster formation of Ni—Mo ions proceeds, and the formation of a Ni-Mo alloy is difficult because Ni—Mo ions do not participate in the reduction reaction. However, an excessive amount of sodium citrate increases side reactions during plating, thereby reducing plating efficiency. It can be seen that Examples 12 and 13 prepared by adjusting the sodium citrate concentration to ¼ times and 2 times compared to the production conditions of Example 1 have a hydrogen evolution reaction activity that is less than that of Example 1.

FIG. 3B is a graph showing the hydrogen evolution reaction activity of Examples 1, 2, 3, 4, and 5 prepared by using the molybdenum precursor concentration as a variable to limit the concentration range of the molybdenum precursor. At this time, the nickel-plated electrode control group is Comparative Example 3, and the precious metal electrode control group is Comparative Example 4.

From FIG. 3B, it can be seen that Example 1 in which molybdenum oxide was clearly mixed between the Ni-Mo-based alloys, had the best activity. Example 5, in which the concentration of the molybdenum precursor was highest, showed the lowest hydrogen evolution reaction, which means that the 20 mM condition is preferably excluded from the concentration range of the molybdenum precursor.

FIG. 3C is a graph showing the hydrogen evolution reaction activity of Examples 1, 6, 7, and 8 prepared by using the applied current density as a variable. It can be seen that Example 1, in which the applied current density was optimized to 0.5 A/cm², had the best activity.

FIG. 3D is a graph of the hydrogen evolution reaction activity of Example 14 prepared to confirm the change in the hydrogen evolution reaction according to the precursor dissolution sequence. In order to examine the effect when the dissolution of the molybdenum precursor is performed before the dissolution of sodium citrate in the manufacturing step of Example 1 above, in the order of producing the plating solution of Example 1, the dissolution of the nickel precursor and the dissolution of the molybdenum precursor were firstly performed, and then sodium citrate dissolution was performed to prepare Example 14. The hydrogen evolution reaction activity was better in Example 1 than in Example 14, which means that the preparation sequence of the solution affects the final electrode.

FIG. 3E shows the hydrogen evolution reaction activity of the electrodes prepared in Examples 9, 10, and 11 by changing the precursor concentration of the plating condition of Example 1, having optimal activity by 0.5 times, 2 times, and 3 times, respectively. This is set to determine the precursor concentration range of the precursor plating solution. Compared to Example 9 corresponding to 0.5 times the precursor concentration and Example 10 corresponding to twice the precursor concentration, Example 1 corresponding to 1 times the precursor concentration showed the most excellent hydrogen evolution reaction activity. This means that the concentration conditions suggested for preparing Example 1 are most suitable for preparing the catalyst.

FIG. 3F is a comparison of the difference in hydrogen evolution reaction activity of Example 1 and Comparative Example 5, and FIG. 3G is a STEM image and EDS mapping results of Comparative Example 5.

Comparative Example 5 is a nickel-molybdenum alloy electrode manufactured by reflecting the plating solution and conditions of the nickel-molybdenum electrode that have been generally applied in the related art. The plating solution of this electrode was prepared by titrating the pH to 10 using an aqueous ammonia solution and was prepared by increasing the concentration of the molybdenum precursor to the same level of 0.1 M as that of nickel. In the STEM image and EDS mapping results, in Comparative Example 5, the Ni-Mo-based alloy and the Mo oxide phase were not clearly distinguished. Compared to Comparative Example 5, Example 1 has a better hydrogen evolution reaction activity, which shows that the structure in which the Ni-Mo-based alloy is uniformly distributed by being distinguished from the Mo oxide may overcome the activity limit of the conventional nickel-molybdenum electrode.

### 4. Comparison of Overvoltage for Generating Appropriate Current Density Using Electrode Specimens According to Comparative Examples and Examples

The overvoltage for generating a -100 A/cm² current density at room temperature with 1 M KOH was measured using the electrode specimens according to Comparative Examples and Examples, and the results are shown in Table 3 below.

TABLE 3

| | |
|---|---|
| Division | Overvoltage |
| Example 1 | 86 mV |
| Example 2 | 119 mV |
| Example 3 | 110 mV |
| Example 4 | 118 mV |
| Example 5 | 137 mV |
| Example 6 | 121 mV |
| Example 7 | 113 mV |
| Example 8 | 113 mV |
| Comparative Example 3 | 267 mV |
| Comparative Example 4 | 122 mV |

As can be seen from Table 3, and as can be seen from the results of electroplating in Examples 1, 6, 7, and 8 in which the applied current density was adjusted and in Examples 1, 2, 3, 4, and 5 in which the concentration of the molybdenum precursor was adjusted, it can be seen that Example 1 in which molybdenum oxide was clearly mixed between the Ni-Mo-based alloys showed the lowest hydrogen evolution reaction overvoltage, thereby exhibiting the highest hydrogen evolution reaction activity.

### 5. Analysis of Components Contained in Electrode Specimens According to Comparative Examples and Examples

The components of the catalyst layer formed on the surface of the electrode base material were analyzed for the electrode specimens prepared according to Comparative Examples and Examples, and the results are shown in Table 4.

TABLE 4

| Division | Ni (wt%) | Mo (wt%) | O (wt%) |
|---|---|---|---|
| Example 1 | 41.7 | 20.6 | 37.7 |
| Example 2 | 49.6 | 21.1 | 29.3 |
| Example 3 | 38 | 23.9 | 39.1 |
| Example 4 | 34.1 | 26.0 | 39.9 |
| Example 5 | 21.5 | 18.6 | 59.9 |
| Example 6 | 48.1 | 23.8 | 28.1 |
| Example 7 | 42.5 | 26.4 | 31.1 |
| Example 8 | 38.1 | 21.5 | 40.4 |
| Example 9 | 50.4 | 19.0 | 30.6 |
| Example 10 | 48.4 | 27.7 | 23.9 |
| Example 11 | 75.5 | 8.3 | 16.2 |
| Example 12 | 60.8 | 12.1 | 27.1 |
| Example 13 | 58.2 | 18.6 | 23.2 |
| Example 14 | 39.0 | 22.2 | 38.8 |
| Comparative Example 5 | 60.6 | 23.8 | 15.6 |

As can be seen in Table 4, the catalyst layer formed on the electrode specimen according to the embodiment was confirmed to be formed of Ni: 30 wt% to 55 wt%, Mo: 19 wt% to 30 wt%, and O: 20 wt% to 45 wt%.

### 6. Image Component Analysis of Electrode Specimens According to the Example

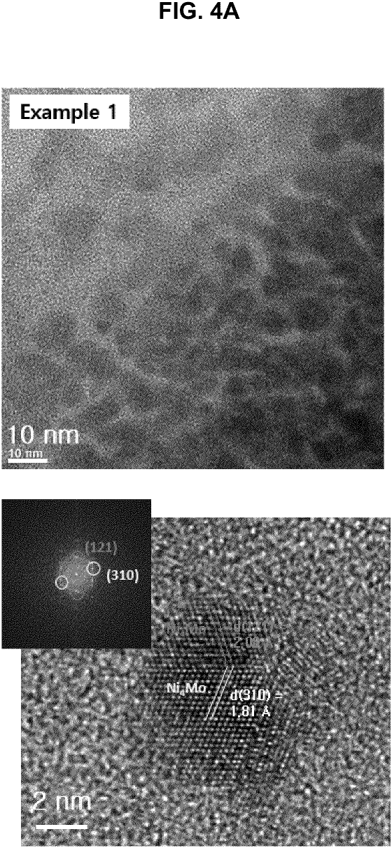

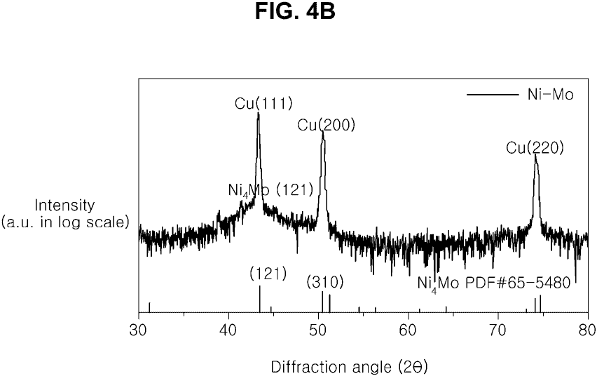

A TEM image and XRD were analyzed for the electrode specimen according to Example 1, and the results are shown in FIGS. 4A and 4B.

FIG. 4A is a high-resolution TEM image of an electrode specimen according to Example 1 and FIG. 4B is an XRD analysis result.

As shown in FIG. 4A , it was confirmed that the particles which are observed in FIG. 4A was composed of Ni₄Mo particles through lattice structure analysis. That is, it can be seen that the 10 nanometer-level particles constituting Example 1 are nickel-molybdenum alloy containing Ni₄Mo.

As can be seen from FIG. 4B, it was confirmed that a signal corresponding to the (111) plane of the Ni₄Mo crystal structure appeared near 43.5°, similar to the result confirmed in FIG. 4A.

### 7. XPS Binding Energy Analysis for Each Catalyst Element of the Electrode Specimen According to the Example

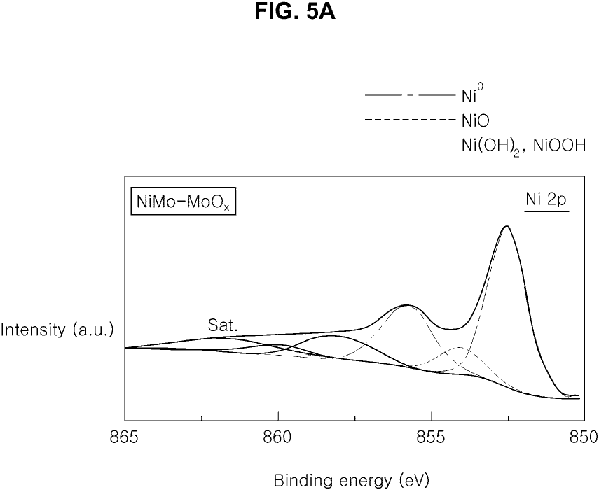

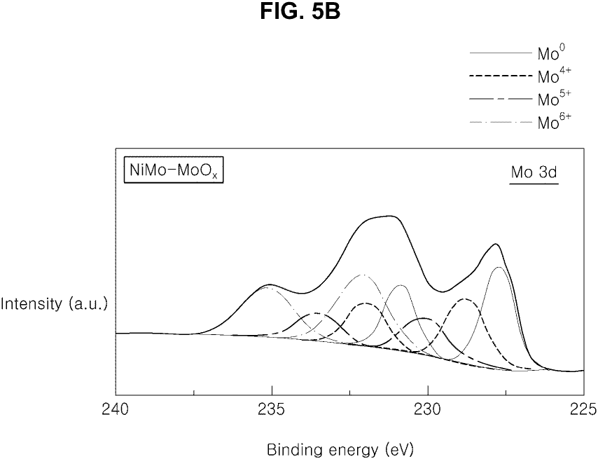

XPS binding energy for each catalytic element was analyzed for the electrode specimen according to Example 1, and the results are shown in FIGS. 5A and 5B.

FIGS. 5A and 5B are results of XPS binding energy for each catalytic element of the electrode specimen according to Example 1.

As can be seen from FIGS. 5A and 5B, through the results of the Ni 2p binding energy section, it was confirmed that most of the nickel exists in the form of a nickel-molybdenum alloy (Ni⁰).

And, in the case of molybdenum, it was confirmed that, in addition to the nickel-molybdenum alloy form (Mo⁰), it existed in the form of oxides having various oxidation numbers such as Mo⁴⁺, Mo⁵⁺, and Mo⁶⁺.

Although the present disclosure has been described with reference to the accompanying drawings and the above-described preferred embodiment, the present disclosure is not limited thereto and is limited to the following claims. Therefore, a person skilled in the art may variously modify and modify this disclosure within the scope, not departing from the technical idea of the claims to be described later.

1. A method of manufacturing an electrode used for water electrolysis, the method comprising:
preparing catalyst materials including a solvent, a nickel (Ni) precursor, a molybdenum (Mo) precursor, and sodium citrate;
preparing an electrode base material;
obtaining a plating solution by dissolving the nickel (Ni) precursor, the molybdenum (Mo) precursor, and the sodium citrate in the solvent; and
forming a catalyst layer on the surface of the electrode base material by immersing the electrode base material in the plating solution and applying an electric current.

2. The method of claim 1, wherein in the preparing of the catalyst materials, the solvent is distilled water, the nickel precursor is a compound comprising at least one of nickel chloride, nickel sulfide, nickel sulfate, nickel acetate, and hydrates thereof, and the molybdenum precursor is a compound comprising at least one of sodium molybdate, ammonium molybdate, and hydrates thereof.

3. The method of claim 1, wherein in the preparing of the electrode base material, the electrode base material is a copper (Cu) or nickel (Ni) foam or plate.

4. The method of claim 3, wherein the preparing of the electrode base material comprises:
preparing the electrode base material through molding; and
removing an oxide film formed on a surface of the electrode base material prepared through molding.

5. The method of claim 1, wherein obtaining of the plating solution comprises sequentially dissolving the nickel precursor, the sodium citrate, and the molybdenum precursor in the solvent.

6. The method of claim 1, wherein in the obtaining of the plating solution, 0.05 M to 0.3 M of the nickel precursor, 0.1 M to 0.6 M of the sodium citrate, and 1 mM to 10 mM of the molybdenum precursor in the prepared solvent.

7. The method of claim 6, wherein in the obtaining of the plating solution, 0.1 M to 0.2 M of the nickel precursor, 0.1 M to 0.4 M of the sodium citrate, and 1.25 mM to 10 mM of the molybdenum precursor are dissolved in the solvent.

8. The method of claim 1, wherein the forming of the catalyst layer comprises performing electroplating by applying an electric current of a current density of 0.1 A/cm2 to 3 A/cm2 to the electrode base material immersed in the plating solution.

9. The method of claim 8, wherein the electroplating is performed for 30 to 600 seconds.

10. The method of claim 8, wherein the forming of the catalyst layer further comprises:
stirring the plating solution prepared before performing the electroplating at a speed of 300 rpm or more; and
maintaining the temperature of the plating solution at a temperature of 20° C. to 40° C.

11. An electrode used for water electrolysis, the electrode comprising:
an electrode base material; and
a catalyst layer formed on a surface of the electrode base material, the catalyst layer comprising molybdenum oxide and a Ni-Mo-based alloy.

12. The electrode of claim 11, wherein the catalyst layer is deposited such that the molybdenum oxide and the nano-sized Ni-Mo-based alloy are uniformly distributed on the surface of the electrode base material.

13. The electrode of claim 11, wherein the catalyst layer comprises 30% to 55% by weight of nickel (Ni), 19% to 30% by weight of molybdenum (Mo), and 20% to 45% by weight of oxygen (O).
